(19) United States
(12) Patent Application Publication
(10) Pub. No.: US 2012/0075277 A1
(43) Pub. Date: Mar. 29, 2012

(54) LIQUID CRYSTAL DISPLAY APPARATUS AND METHOD OF DRIVING THE SAME

(75) Inventor: Ryuichi HIRAYAMA, Musashimurayama-shi (JP)

(73) Assignee: CASIO COMPUTER CO., LTD., Tokyo (JP)

(21) Appl. No.: 13/246,501

(22) Filed: Sep. 27, 2011

(30) Foreign Application Priority Data
Sep. 27, 2010 (JP) 2010-215730

(51) Int. Cl. G09G 3/36; G09G 5/00

(52) U.S. Cl. 345/209; 345/96

(57) ABSTRACT

A liquid crystal display apparatus includes an active-matrix type display panel and a signal drive circuit. The active-matrix type display panel includes a pair of substrates, a liquid crystal layer interposed between the substrates, pixel electrodes arranged on one of the substrates in rows and columns, switching elements connected to the pixel electrodes, scan lines connected to the switching elements, and signal lines connected to the switching elements. Each signal line extends between two columns of the pixel electrodes, and any two pixel electrodes adjacent in the row direction use one signal line in common. One of two pixel electrodes is connected to an odd-numbered scan line, and the other of two pixel electrodes is connected to an even-numbered scan line. The signal drive circuit supplies display signals to the pixel electrodes through the signal lines, and to invert the display signal in polarity at every two other scan lines.

### CROSS-REFERENCE TO RELATED APPLICATIONS

This application is based upon and claims the benefit of priority from prior Japanese Patent Application No. 2010-215730, filed Sep. 27, 2010, the entire contents of which are incorporated herein by reference.

### BACKGROUND OF THE INVENTION

1. Field of the Invention

The present invention relates to a liquid crystal display of the type in which one signal line is used for two pixels adjacent in the row direction, and also to a method of driving the liquid crystal display

2. Description of the Related Art

In recent years, liquid crystal displays of the active-matrix type using thin film transistors (TFTs) as switching elements have been developed in increasing numbers. Any liquid crystal display of this type has a plurality of pixels arranged in the form of a matrix, a scan drive circuit (scan driver) configured to generate a scan signal for scanning the pixels in units of rows, and a signal drive circuit (signal driver) configured to supply display signals to the pixels.

In the liquid crystal display of this type, each pixel is composed of a TFT, a pixel electrode connected to the TFT, and a liquid crystal layer interposed between the pixel electrode and the common electrode. A voltage is applied to the liquid crystal layer interposed between the pixel electrode and the common electrode to which a common voltage is applied. As a result, the transmittance of the liquid crystal is changed, whereby the liquid crystal display displays an image.

As is known, the liquid crystal has its characteristics degraded as a DC voltage is applied to the liquid crystal for a long time. In order to prevent the characteristic degradation, the voltage applied to the liquid crystal is inverted in polarity in most cases. Known as methods of alternating the voltage in polarity are line inversion drive, column inversion drive, and dot inversion drive. In the line inversion drive, the voltage polarity is inverted at every other row of pixels. In the column alternation drive, the voltage polarity is inverted at every other column of pixels. In the dot inversion drive, the voltage polarity is inverted at every other pixel.

Most liquid crystal displays have a great number of pixels arranged in rows and columns. The more pixels are so arranged, the more scan lines and signal lines will be used to transmit scan signals and display signals. The increase in the number of scan lines and signal lines may result in a size increase of the liquid crystal display. In order to minimize the size of the liquid crystal display, it is desirable to achieve the so-called “narrow frame,” or to reduce the area other than the display area.

One of the techniques of achieving the narrow frame is proposed in, for example, Jpn. Pat. Appln. KOKAI Publication No. 2008-268843. In this technique, every two pixels arranged, respectively on one side and the other side of a signal line share the signal line, and are scanned by using different scan lines. If the number of scan lines increases two times, the number of signal lines decreases to half. If the total number of lines, i.e., the sum of the number of scan lines and that of signal lines, decreases, the lines outside the display area and the terminals of the scan driver, and the terminals of the signal driver will decrease. As a result, the narrow frame will be accomplished.

In the technique disclosed in Jpn. Pat. Appln. KOKAI Publication No. 2008-268843, of the pixels of each row, the pixels of odd-numbered columns are connected to one scan line, whereas the pixels of even-numbered columns are connected to another scan line. During the manufacture of a liquid crystal display, the pixel electrodes, the scanning lines and the signal lines may undergo pattern displacement (position change in manufacture) in, for example, the direction perpendicular to the scan lines (i.e., column direction in which the signal lines extend). In this case, the pixels of any odd-numbered column differ from those of any even-numbered column in field through voltage ΔV. The difference in field through voltage ΔV results in flicker and display non-uniformity. The flicker and the display non-uniformity are particularly prominent if the pixels are set in a stripe arrangement.

### BRIEF SUMMARY OF THE INVENTION

According to a first aspect of the invention, there is provided a liquid crystal display apparatus comprising an active-matrix type display panel and a signal drive circuit, the active-matrix type display panel comprising: a pair of substrates, a liquid crystal layer interposed between the substrates, a plurality of pixel electrodes arranged on an inner surface of one of the substrates, in rows and columns in a form of a matrix, a plurality of switching elements connected to the pixel electrodes, a plurality of scan lines connected to the switching elements, and a plurality of signal lines connected to the switching elements, wherein the each signal line extends between two columns of the pixel electrodes, and the two pixel electrodes adjacent in the row direction use one signal line in common, one of the two pixel electrodes connected by the switching element to an odd-numbered scan line, and the other of the two pixel electrodes connected by the switching element to an even-numbered scan line; and the signal drive circuit configured to supply display signals to the pixel electrodes through the signal lines, thereby to display an image, and to invert the display signal in polarity at every two other scan lines.

According to a second aspect of the invention, there is provided a method of driving a liquid crystal display apparatus comprising an active-matrix type display panel and a signal drive circuit, the display panel comprising a pair of substrates, a liquid crystal layer interposed between the substrates, a plurality of pixel electrodes arranged on an inner surface of one of the substrates, in rows and columns in the form of a matrix, a plurality of switching elements connected to the pixel electrodes, a plurality of scan lines connected to the switching elements, and a plurality of signal lines connected to the switching elements, each signal line extending between two columns of pixel electrodes, and any two pixel electrodes adjacent in the row direction using one signal line in common, one connected by a switching element to an odd-numbered scan line, and the other connected by a switching element to an even-numbered scan line, and the signal drive circuit configured to supply display signals to the pixel electrodes through the signal lines, thereby to display an image, the method comprising inverting the display signal is inverted in polarity at every two other scan lines by the signal drive circuit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing the outer appearance of a mobile phone that is an example of the electronic apparatus having a liquid crystal display according to an embodiment of this invention;

FIG. 2 is a diagram showing the overall configuration of the liquid crystal display according to the embodiment of the invention;

FIG. 3 is a diagram showing how the pixels are connected in the embodiment of the invention;

FIG. 4 is a diagram showing the configuration of the signal driver incorporated in the embodiment of the invention;

FIG. 5A is a timing chart explaining how the liquid crystal display according to the embodiment of the invention displays an odd-numbered frame;

FIG. 5B is a timing chart explaining how the liquid crystal display according to the embodiment of the invention displays an even-numbered frame;

FIG. 6 is a diagram showing how the field through voltage ΔV changes when pattern displacement takes place;

FIG. 7 is a diagram showing how voltage VLCD changes when a display signal Vsig is supplied to each pixel of the display panel while pattern displacement occurring as shown in the lower-left part of FIG. 6;

FIG. 8A is a diagram explaining how an odd-numbered frame is displayed if the dot inversion drive is performed while a pattern displacement is occurring as shown in the lower-left part of FIG. 6;

FIG. 8B is a diagram explaining how an even-numbered frame is displayed if the dot inversion drive is performed while a pattern displacement is occurring as shown in the lower-left part of FIG. 6;

FIG. 9A is a diagram explaining how an odd-numbered frame is displayed if the column inversion drive is performed while a pattern displacement is occurring as shown in the lower-left part of FIG. 6;

FIG. 9B is a diagram explaining how an even-numbered frame is displayed if the column inversion drive is performed while a pattern displacement is occurring as shown in the lower-left part of FIG. 6;

FIG. 10A is a diagram explaining how an odd-numbered frame is displayed if frame inversion drive is performed while a pattern displacement is occurring as shown in the lower-left part of FIG. 6;

FIG. 10B is a diagram explaining how an even-numbered frame is displayed if frame inversion drive is performed while a pattern displacement is occurring as shown in the lower-left part of FIG. 6;

FIG. 11A is a diagram explaining how an odd-numbered frame is displayed if line inversion drive is performed while a pattern displacement is occurring as shown in the lower-left part of FIG. 6;

FIG. 11B is a diagram explaining how an even-numbered frame is displayed if line inversion drive is performed while a pattern displacement is occurring as shown in the lower-left part of FIG. 6;

FIG. 12A is a diagram explaining how a display panel different from the panel of this invention in pixel-connection structure displays an odd-numbered frame if line inversion drive is performed; and

FIG. 12B is a diagram explaining how the display panel different from the panel of this invention in pixel-connection structure displays an even-numbered frame if line inversion drive is performed.

### DETAILED DESCRIPTION OF THE INVENTION

An embodiment of this invention will be described with reference to the accompanying drawings.

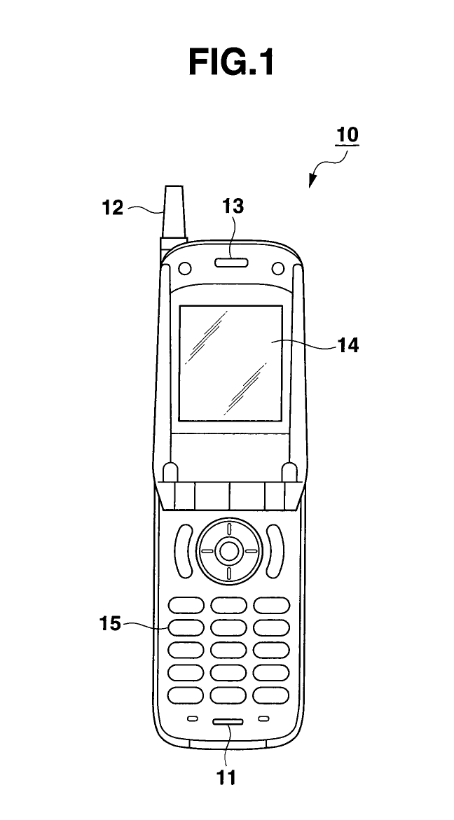

FIG. 1 is a diagram showing the outer appearance of a mobile phone, i.e., an example of the electronic apparatus that has a liquid crystal display according to an embodiment of this invention. As shown in FIG. 1, the mobile phone 10 includes a microphone 11, an antenna 12, a speaker 13, a liquid crystal display 14, and a console unit 15.

The microphone 11 is configured to convert the voice of the user at the mobile phone 10 to an electric signal. The antenna 12 enables the mobile phone 10 to communicate with a base station (not shown). The speaker 13 is configured to receive an audio signal the antenna 12 has received, and to convert the audio signal to voice. The liquid crystal display 14 is configured to display various types of images. The console unit 15 is the unit the user may operate to use the mobile phone 10.

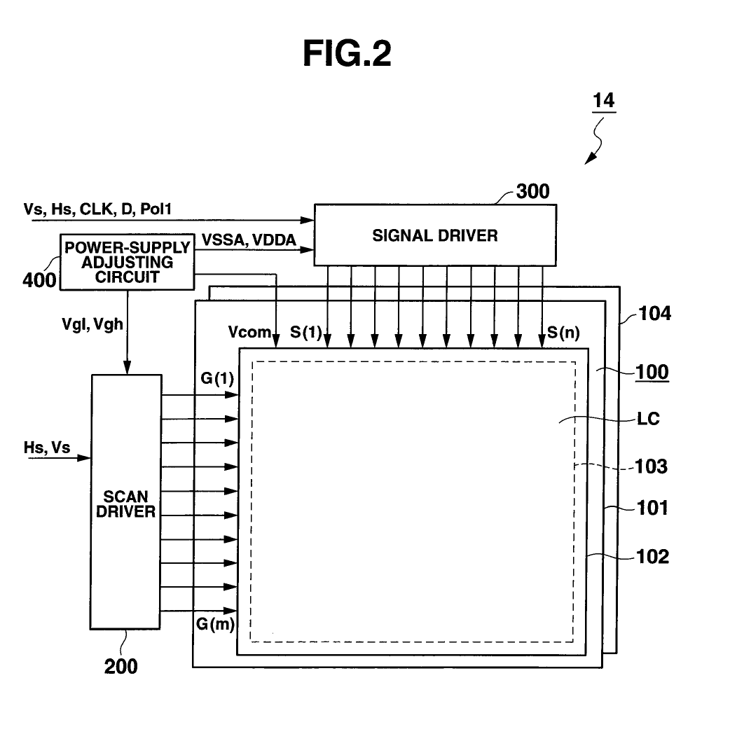

FIG. 2 is a diagram showing the overall configuration of the liquid crystal display 14 according to the embodiment of the invention. As shown in FIG. 2, the liquid crystal display 14 includes a display panel 100, a scan driver 200, a signal driver 300, and a power-supply adjusting circuit 400.

The display panel 100 is the display unit configured to display an image represented by the video data D supplied externally of the liquid crystal display 14. The display panel 100 comprises a pixel substrate 101, a counter substrate 102, and a liquid crystal layer LC interposed between the pixel substrate 101 and the substrate 102. The display panel 100 further includes a backlight 104 provided on the back.

A plurality of scan lines G(i) (i=1, 2, . . . , m) and a plurality of signal lines S(j) (j=1, 2, . . . , n) are arranged on the inner surface of the pixel substrate 101. The inner surface of the pixel substrate 101 faces the counter substrate 102. At the intersections of the scan lines G(i) and the signal liens S(j), pixel electrodes are arranged, each defining a liquid crystal display element. Each pixel electrode, a counter electrode provided on the counter substrate, a part of liquid crystal interposed between the pixel electrode and the counter electrode constitute a pixel. The pixel electrode is made of a transparent conductive film made of indium tin oxide (ITO) and is connected to a scan line G(i) and a signal line S(j) by a thin film transistor (TFT) used as a switching element.

In the display panel 100, the counter substrate 102 is arranged, facing the pixel substrate 101. The counter electrode is formed on the inner surface of the counter substrate 102, which opposes the pixel substrate 101. The power-supply adjusting circuit 400 applies a common voltage Vcom (Vcom+ or Vcom−) to the counter electrode.

The pixel substrate 101 and the counter electrode 102 are bonded, at their edges, with a seal material 103. The seal material 103 prevents the liquid crystal LC from leaking from the gap between the pixel substrate 101 and the counter electrode.

In this configuration, each pixel is thereby constituted by one pixel electrode formed on the pixel substrate 101, the counter electrode formed on the counter substrate 102, and a part of liquid crystal LC, which is interposed between the pixel electrode and the counter electrode.

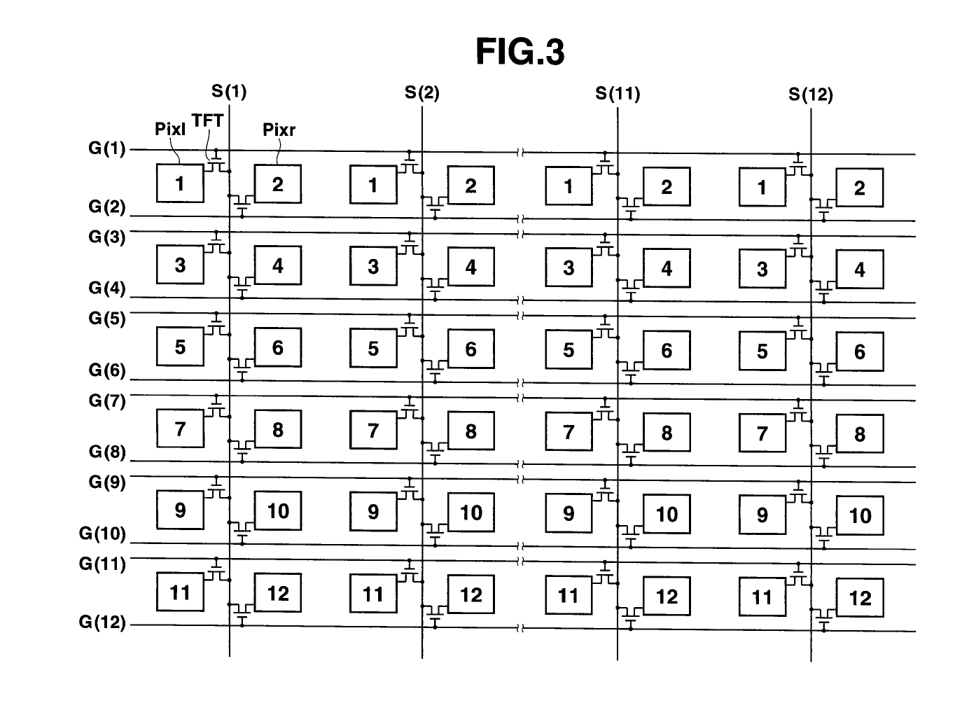

FIG. 3 is a diagram showing how the pixels are connected in the embodiment. As seen from FIG. 3, the display panel 100 of the embodiment is a panel of stripe arrangement, in which pixels are arranged in the form of stripes. In this embodiment, one signal line S(j) is provided for every two pixels arranged in the row direction. That is, any two pixels adjacent in the row direction share one signal line S(j) that extends between them. Further, any two pixels sharing one signal line S(j) are connected to two scan lines G(i) by two TFTs, respectively. Assume that in the embodiment, one of two pixels sharing a certain signal line S(j), which lies on the left (one side) of the signal line is connected to an odd-numbered (upper) scan line G(i) (i=1, 3, 5, . . . , 2k−1), whereas the other of the two pixels, which lies on the right (the other side) of the signal line is connected to an even-numbered (lower) scan line G(i) (i=2, 4, 6, . . . , 2k).

More specifically, the signal line S(1), for example, extends between two pixels Pixl and Pixr at the end of the first row as shown in FIG. 3. The pixel Pixl on the left side of the signal line S(1) is connected to the scan line G(1), and the pixel Pixr on the right side of the signal line S(1) is connected to the scan line G(2). The remaining pixels of the first row and the pixels of any other row are similarly connected to the scan lines G(i). In the configuration of FIG. 3, the pixel on the left side of any signal line S(j) is connected to an odd-numbered scan line G(i), and the pixel on the right side of any signal line S(j) is connected to an even-numbered scan line G(i). Alternatively, the pixel on the left side of any signal line S(j) may be connected to an even-numbered scan line G(i), and the pixel on the right side of any signal line S(j) may be connected to an odd-numbered scan line G(i). In other words, of the pixels of any two adjacent columns with a signal line S(i) extending between them, those of one column are connected to odd-numbered scan lines G(i), whereas those of the other column are connected to even-numbered scan lines G(i).

Since the pixels are connected to the scan lines G(i) and the signal lines S(j) as shown in FIG. 3, the display panel 100 has twice as many scan lines G(i) as the pixel rows, but has half as many signal lines S(j) as the pixel columns. The display panel 100 of FIG. 3, which has pixels arranged in 6 rows and 24 columns, needs 12 scan lines G(i), but only 12 signal lines S(j).

If the pixels are connected in the conventional manner, 6 scan lines and 24 signal lines, totaling 30 lines, must be used. In contrast, the configuration of FIG. 3 needs 12 scan lines and 12 signal liens, totaling 24 lines only. Thus, the number of lines extending from the display area is smaller by 6 than in the conventional display panel. Moreover, the total number of terminals used in the scan driver 200 and signal driver 300 is smaller by 6. The narrow frame can therefore be accomplished.

The scan driver 200 comprises a shift register and is configured to supply scan signals, one after another, to the scan lines G(i) of the display panel 100. Every time a vertical sync signal Vs is input from a control circuit (not shown), the scan driver 200 starts supplying the scan signals to m scan lines, sequentially. Every time a horizontal sync signal Hs is input from the control circuit, the scan driver 200 switches the scan signal from gate-off level Vgl to gate-on level Vgh to turn on the TFTs of one row. The display signal coming from the signal driver 300 is thereby supplied to the pixel electrodes through the signal lines S(j) connected to the TFTs of the row. The vertical sync signal Vs is supplied for one vertical period (one-frame period), causing the display panel 100 to display one image frame. In this embodiment, the horizontal sync signal Hs is supplied for a period (½ horizontal period) that is half the horizontal period for supplying a display signal (grayscale signal) to the pixels of one row (associated with two adjacent scan lines).

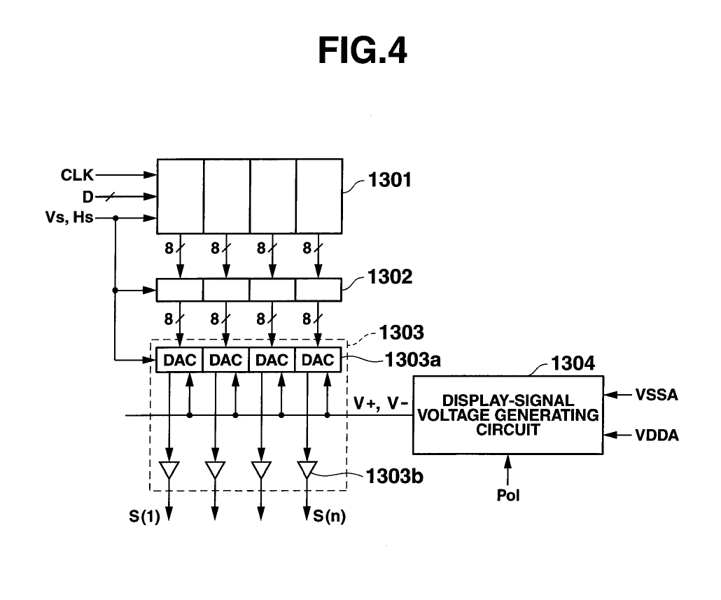

The signal driver 300, which functions as a signal drive circuit, supplies a display signal to the signal lines S(j) of the display panel 100. As shown in FIG. 4, the signal driver 300 includes a sampling memory 1301, a data latch unit 1302, a digital-to-analog (D/A) conversion circuit (DAC) 1303, and a display-signal voltage generating circuit 1304.

The sampling memory 1301 is configured to store video data D, pixel data by pixel data, in response to the horizontal sync signal Hs coming from the control circuit (not shown). To store the video data in this way, the sampling memory 1301 has as many data storage areas as the signal lines S(j) (more precisely, n storage areas, or four areas as shown in FIG. 3). Note that the video data D is, for example, 8-bit digital data.

The data latch unit 1302 acquires the video data D from the storage areas of the sampling memory 1301 at a time, on receiving a horizontal sync signal Hs from the control circuit (not shown). The data latch unit 1302 then outputs the video data D to the D/A conversion circuit 1303.

The D/A conversion circuit 1303 decodes the video data output from the data latch unit 1302, generating grayscale level data. Then, the D/A conversion circuit 1303 selects one of the display signals supplied from the display-signal voltage generating circuit 1304, which corresponds to the grayscale level data. The display signal selected is output to the associated signal line S(j). The D/A conversion circuit 1303 has a plurality of DAC units 1303a and a plurality of output amplifier units 1303b. The DAC units 1303a select the display signals supplied from the display-signal voltage generating circuit 1304, in accordance with the video data D decoded. The output amplifier units 1303b amplify the display signals the DAC units 1303a have selected. The display signals so amplified are output to the signal lines S(j). The display signals Vsig output to the signal line S(j) are supplied to pixel electrodes via the TFTs turned on by the scan driver 200. A voltage VLCD, i.e., difference between the pixel electrode voltage Vpix generated at the pixel electrodes based on the display signal Vsig and the common voltage Vcom applied to the common electrode, is therefore applied to the liquid crystal layer LC interposed between the pixel electrodes and the common electrode. As a result, the pixels display the image represented by the video data D.

The display-signal voltage generating circuit 1304 generates a display signal at one of the grayscale levels the video data D may have (for example, 256 levels if the video data D is 8-bit digital data), by performing the resistance division of dividing the prescribed positive power-supply voltage VDDA and negative power-supply voltage VSSA (VDDA>Vcom>VSSA), by using resistors corresponding to the grayscale levels, respectively.

Liquid crystal has its characteristics changed when applied with a DC voltage for a long time. Hence, in order to lengthen the lifetime of the liquid crystal, the voltage applied to the liquid crystal needs to be inverted in polarity (determined by the difference between the pixel electrode voltage and the common voltage). For the purpose of altering the voltage in polarity, the display-signal voltage generating circuit 1304 used in the embodiment is configured to generate two display signals, i.e., display signal V+ of positive polarity and display signal V− of negative polarity, which are higher and lower, respectively, than the common voltage Vcom. The display signals V+ and the display signal V− can have various voltage levels as many as the grayscale levels the video data D may assume (for example, 256 levels if the video data D is 8-bit digital data). Thus, the display-signal voltage generating circuit 1304 selects the display signal V+ of positive polarity or the display signal V− of negative polarity, in accordance with a polarity inversion control signal Pol supplied from the control circuit (not shown). The display signal, so selected, is supplied to the D/A conversion circuit 1303. More precisely, the display-signal voltage generating circuit 1304 selects the display signal V+ if the polarity inversion control signal Pol is at high level (H), and selects the display signal V− if the polarity inversion control signal Pol is at low level (L).

The power-supply adjusting circuit 400 shown in FIG. 2 receives power from a prescribe power supply and generates power-supply voltages Vgl and Vgh for the scan driver 200, power-supply voltages VSSA and VDDA for the signal driver 300, and the common voltage Vcom. The power-supply voltages Vgl and Vgh are applied to the scan driver 200. The power-supply voltages VSSA and VDDA are applied to the signal driver 300. The common voltage Vcom is applied to the counter electrode. The power-supply adjusting circuit 400 has the function of a common voltage applying circuit, and can generate a common voltage Vcom+ of positive polarity and a common voltage Vcom− of negative polarity, which are, respectively, higher and lower than the display signal Vsig. The power-supply adjusting circuit 400 selects the common voltage Vcom+ or the common voltage Vcom− in accordance with the polarity inversion control signal Pol supplied from the control circuit (not shown). The common voltage selected, i.e., Vcom+ or Vcom−, is applied to the counter electrode formed on the counter substrate 102. The power-supply adjusting circuit 400 selects the common voltage Vcom− if the polarity inversion control signal Pol is at high level (H), and selects the common voltage Vcom+ if the polarity inversion control signal Pol is at low level (L).

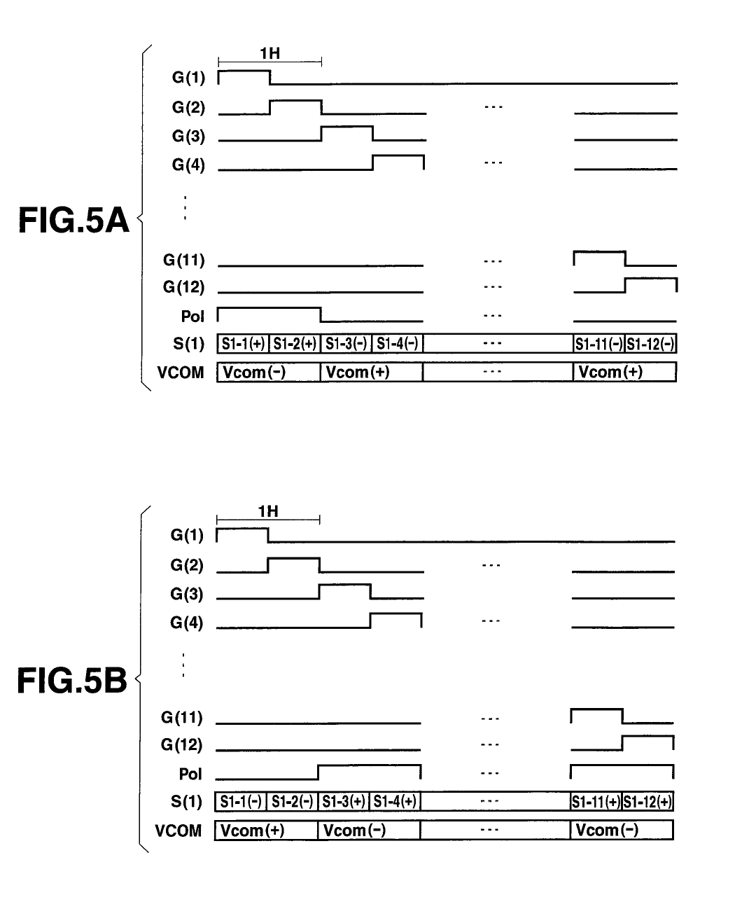

How the liquid crystal display operates will be explained below, with reference to FIG. 5A and FIG. 5B. FIG. 5A and FIG. 5B are timing charts explaining the operation of the liquid crystal display according to the embodiment. More precisely, FIG. 5A shows how an odd-numbered frame is displayed and FIG. 5B shows how an even-numbered frame is displayed. Both FIG. 5A and FIG. 5B are based on the assumption that the liquid crystal display includes 12 scan lines G(i). The number of scan lines provided is not limited to 12, nevertheless.

On receiving the vertical sync signal Vs from the control circuit (not shown), the scan driver 200 recognizes that one vertical scan period starts so that the display panel 100 may display one image. Thereafter, every time the horizontal sync signal Hs is input from the control circuit (not shown), the scan driver 200 sequentially switches the voltage level of the scan signal, from the gate-off level Vgl to the gate-on level Vgh, first on the scan line G(1). When the voltage level of the scan signal on the scan line G(1) changes to the gate-on level Vgh, the TFTs connected to the scan line G(1) are selected at the same time. The display signal can therefore be supplied to every other pixel of one row in the display panel 100. To be more specific, when the scan signal on the scan line G(1) changes to the gate-on level Vgh, the TFTs connected to the pixels identified with “1” in FIG. 3 are simultaneously selected, and the display signal can be supplied to these TFTs. Next, the voltage level of the scan signal on the scan line G(2) changes to the gate-on level Vgh. The TFTs connected to the pixels identified with “2” in FIG. 3 are simultaneously selected, and the display signal can be supplied to these TFTs. Thereafter, as the voltage levels of the scan signals on the other scan lines G(3) to G(12) change to the gate-on level Vgh, the TFTs connected to pixel groups 3, 4, 5, . . . 12 are sequentially selected, and the display signals on the scan lines G(3) to G(12) can be supplied to these TFTs.

On receiving the vertical sync signal Vs from the control circuit (not shown), the signal driver 300 recognizes that one vertical scan period starts so that the display panel 100 may display one image. Thereafter, every time the horizontal sync signal Hs is input from the control circuit (not shown), the signal driver 300 recognizes the start timing of supplying the display signal to each pixel. Then, the signal driver 300 acquires video data D for the pixels of half the rows (either the odd-numbered rows or the even-numbered rows). The signal driver 300 decodes the video data D, generating grayscale level data. The signal driver 300 then supplies, to the signal lines S(j), the display signals corresponding to the grayscale levels at which the image represented by the video data D should be displayed at the pixels of half the rows.

In the embodiment, the line inversion drive (horizontal line inversion drive) is performed on the display panel 100. That is, the voltage polarity is inverted at every other pixel row in the display panel 100. To achieve the line inversion drive, the inversion control signal Pol is inverted in polarity in each horizontal scan period (H) for which to supply a display signal to the pixels constituting one row in the display panel 100.

As described above, the scan driver 200 selects every other TFT of one row so that it may operate in synchronism with the signal driver 300. Hence, the display signals that the signal driver 300 supplies are supplied to the pixel electrodes of the pixels through every other TFT of one row. Note that the power-supply adjusting circuit 400 applies the common voltage Vcom (either Vcom+ or Vcom−) to the counter electrode formed on the counter electrode 102 and opposed to the pixel electrodes. The liquid crystal interposed between the pixel electrodes and the counter electrode is therefore applied with voltage Vpix that is the difference between the common voltage Vcom and the pixel electrode voltage based on the display signal. Since liquid crystal has its transmittance changed in accordance with the voltage applied to it, the pixels can have desirable grayscale (luminance) levels if the transmittance of the liquid crystal is controlled while the light coming from the backlight provided on the back of the display panel 100 is being applied to the pixels forming the display panel 100.

The polarity inversion will be explained in detail, with reference to FIG. 5A and FIG. 5B. More precisely, FIG. 5A and FIG. 5B explain how the polarity inversion is performed on the signal line S(1). Note that the voltages on the signal lines S(1) to S(4) assume the same polarity at a specific time (though they do not always have the same value).

How an odd-numbered frame is displayed will be explained first. As FIG. 5A shows, while the scan signal on the scan line G(1) remains at gate-on level Vgh for an odd frame, the polarity inversion control signal Pol is set to high level H. In this case, the display-signal voltage generating circuit 1304 selects the display signal V+ of positive polarity. The display signal supplied to the signal line S(1) therefore assumes positive polarity. In FIG. 5A, “S1-1(+)” denotes the display signal supplied to the signal line S(1) while the scan signal on the scan line G(1) remains at the gate-on level Vgh. The power-supply adjusting circuit 400 selects the common voltage Vcom−, i.e., voltage of negative polarity. Therefore, the voltage that is the difference between the pixel voltage Vpix based on the display signal S1-1(+) and the common voltage Vcom− is applied to the pixel at the first row and first column of the display panel 100 (i.e., pixel Pixl shown in FIG. 3). While the scan signal on the scan line G(2) also remains at the gate-on level Vgh, the polarity inversion control signal Pol is set to high level H. In this case, the display-signal voltage generating circuit 1304 selects the display signal V+ of positive polarity. As a result, the display signal on the signal line S(1) assumes positive polarity. As shown in FIG. 5A, while the scan signal on the scan line G(2) remains at the gate-on level Vgh, a display signal S1-2(+) is supplied to the signal line S(1), and the power-supply adjusting circuit 400 selects the common voltage Vcom−, i.e., voltage of negative polarity. Hence, voltage that is the difference between the pixel voltage Vpix based on the display signal S1-2(+) and the common voltage Vcom− is applied to the pixel at the first row and second column of the display panel 100 (i.e., pixel Pixr shown in FIG. 3). All pixels forming the first row of the display panel 100 therefore assume positive polarity.

While the scan signal on the scan line G(3) remains at the gate-on level Vgh, the polarity inversion control signal Pol is set to low level L. In this case, the display-signal voltage generating circuit 1304 selects the display signal V− of negative polarity. The display signal supplied to the signal line S(1) therefore assumes negative polarity. In FIG. 5A, “S1-3(−)” denotes the display signal supplied to the signal line S(1) while the scan signal on the scan line G(3) remains at the gate-on level Vgh. The power-supply adjusting circuit 400 selects the common voltage Vcom+, i.e., voltage of positive polarity. Therefore, the voltage that is the difference between the pixel voltage Vpix based on the display signal S1-3(−) and the common voltage Vcom+ is applied to the pixel at the second row and first column of the display panel 100. While the scan signal on the scan line G(4) also remains at the gate-on level Vgh, the polarity inversion control signal Pol is set to low level L. In this case, the display-signal voltage generating circuit 1304 selects the display signal V− of negative polarity. As a result, the display signal on the signal line S(1) assumes negative polarity. As shown in FIG. 5A, while the scan signal on the scan line G(4) remains at the gate-on level Vgh, a display signal S1-4(−) is supplied to the signal line S(1), and the power-supply adjusting circuit 400 selects the common voltage Vcom+, i.e., voltage of positive polarity. Moreover, the power-supply adjusting circuit 400 selects the common voltage Vcom+, i.e., voltage of positive polarity. Hence, voltage that is the difference between the pixel voltage Vpix based on the display signal S1-4(−) and the common voltage Vcom+ is applied to the pixel at the second row and second column of the display panel 100. All pixels forming the second row of the display panel 100 therefore assume negative polarity.

Thereafter, the polarity inversion control signal Pol is inverted in polarity every time the scan signals on two adjacent scan lines connected to the pixels of an odd-numbered row and to the pixels of an even-numbered row, respectively, are set to the gate-on level Vgh. When the scanning proceeds to the last scan line G(12), the line inversion drive (i.e., one-line inversion drive) is completed for displaying one image (one frame) at the display panel 100.

In order to display an even-numbered frame, the polarity inversion control signal Pol is inverted in polarity as shown in FIG. 5B, or other way around to the polarity inversion performed as shown in FIG. 5A to display an odd-numbered frame. Therefore, all pixels are inverted in polarity, unlike in the case of displaying an odd-numbered frame.

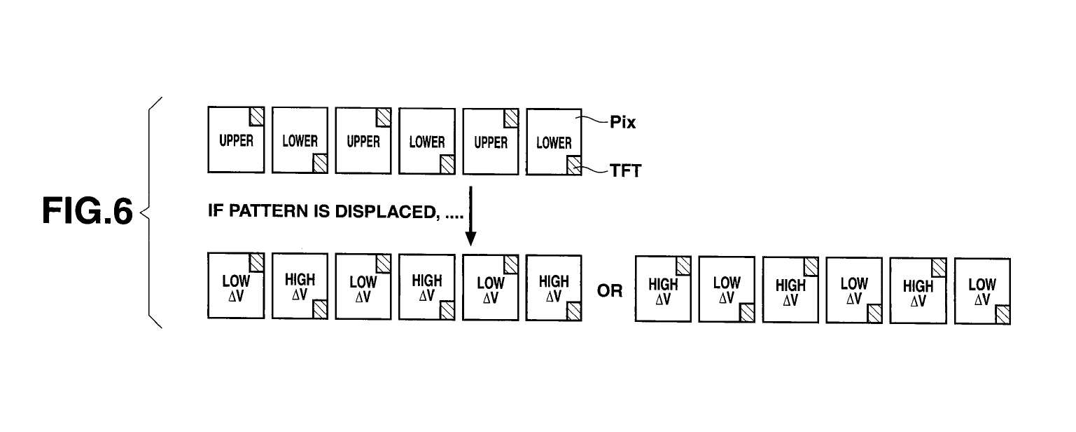

The advantages of the embodiment described above achieves will be described. Consider a display panel, in which two adjacent pixels of one row, connected to a signal line, lie on the sides of the signal line, respectively. As shown in FIG. 6, the TFTs connected to the pixels of any odd-numbered column are connected to an odd-numbered (upper) scan line G(i) extending along the one side of one pixel, and the TFTs connected to the pixels of any even-numbered column are connected to an even-numbered (lower) scan line G(i). Assume that during the manufacture of the pixel substrate 101, the pixels (or pixel electrodes), scan lines G(i) and signal lines S(j) have undergone pattern displacement in, for example, the row direction in which the scan lines G(i) extends. Then, as shown in the lower part of FIG. 6, the field through voltage ΔV of the pixels connected to the odd-numbered (upper) scan line G(i) differs from the field through voltage ΔV of the pixels connected to the even-numbered (lower) scan line G(i). Consequently, the field through voltage ΔV assumes one value for one pixel and another value for any other pixel of the same row of the display panel 100.

Assume that a pattern displacement has occurred as shown in the lower-left part of FIG. 6, lowering the field through voltage ΔV for the pixels connected to an odd-numbered (upper) scan line G(i) from the ordinary value, and raising the field through voltage ΔV for the pixels connected to an even-numbered (lower) scan line G(i) from the ordinary value. Then, the pixels appear black while no voltage is applied to the liquid crystal, and appear white while a voltage of prescribed value is applied to the liquid crystal, thus accomplishing so-called “normally black display.”

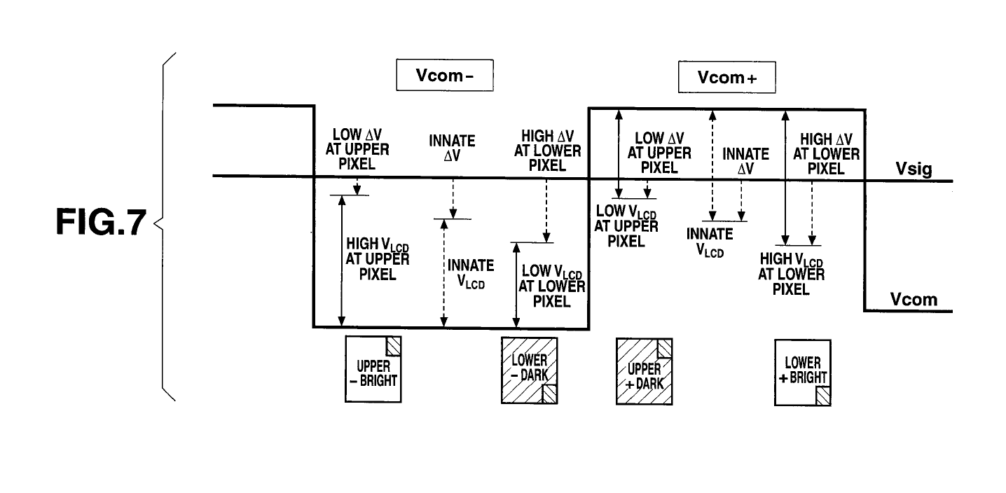

FIG. 7 is a diagram showing how voltage VLCD changes when a display signal Vsig is supplied to each pixel of the display panel 100 while the pattern displacement is occurring as shown in the lower-left part of FIG. 6.

Assume that the display signal Vsig has positive polarity (the common voltage Vcom has therefore negative polarity) as shown in FIG. 7. Then, the pixels connected to any odd-numbered (upper) scan line G(i) are at a voltage Vpix lower than the display signal Vsig supplied to them, by a value smaller than the voltage drop resulting from the innate field through voltage ΔV. The voltage VLCD applied to the pixels connected to the odd-numbered (upper) scan line G(i) is therefore higher than the innate VLCD voltage, and the pixels connected to the odd-numbered (upper) scan line G(i) appear brighter than they appear at their innate grayscale level. In contrast, the pixels connected to any even-numbered (lower) scan line G(i) are at a voltage Vpix higher than the display signal Vsig supplied to them, by a value larger than the voltage drop resulting from the innate field through voltage ΔV. The voltage VLCD applied to the pixels connected to the even-numbered (lower) scan line G(i) is therefore lower than the innate VLCD voltage, and the pixels connected to the even-numbered (lower) scan line G(i) appear darker than they appear at their innate grayscale level.

Also assume that the display signal Vsig has negative polarity (the common voltage Vcom has therefore positive polarity) as shown in FIG. 7. In this case, the pixels connected to any odd-numbered (upper) scan line G(i) appear darker than they appear at their innate grayscale level, whereas the pixels connected to the even-numbered (lower) scan line G(i) appear brighter than they appear at their innate grayscale level.

FIG. 7 does not show the case where pattern displacement occurs as shown in the lower-right part of FIG. 6. If such pattern displacement occurs, the pixel brightness will be opposite to that shown in FIG. 7. In other words, if the display signal Vsig has positive polarity (the common voltage Vcom has therefore negative polarity), the pixels connected to any odd-numbered (upper) scan line G(i) will appear darker than they appear at their innate grayscale level, and the pixels connected to any even-numbered (lower) scan line G(i) will appear brighter than they appear at their innate grayscale level. If the display signal Vsig has negative polarity (the common voltage Vcom therefore has positive polarity), the pixels connected to any odd-numbered (upper) scan line G(i) will appear brighter than they appear at their innate grayscale level, and the pixels connected to any even-numbered (lower) scan line G(i) will appear darker than they appear at their innate grayscale level.

In consideration of such changes in the field through voltage ΔV, a specific connection of the pixels and scan lines G(i) and a specific inversion drive are used for the display panel 100 in the embodiment, thereby suppressing the generation of plane flicker, vertical stripes and horizontal stripes.

The display panel 100 may be driven by any method other than the line inversion drive shown in FIG. 7. Known as other methods are the column inversion drive, the dot inversion drive, and the frame inversion drive. In the column inversion drive (also called vertical inversion drive), the polarity is inverted at every other pixel column. In the dot inversion drive, the polarity is inverted at every other pixel. In the frame inversion drive, the polarity is inverted at every other frame.

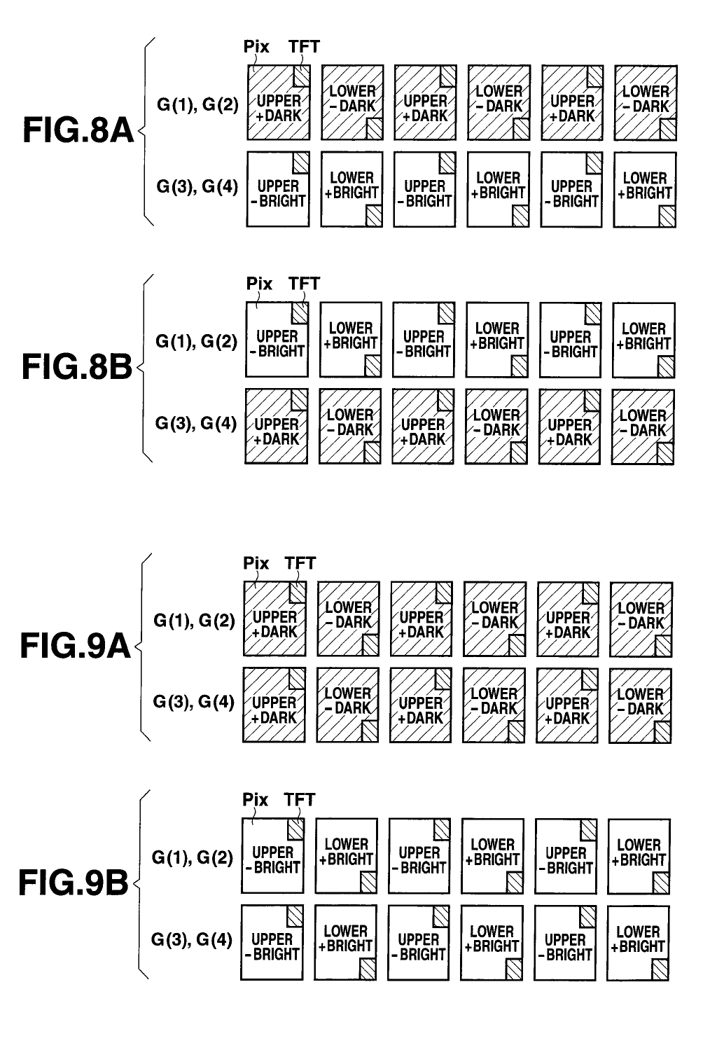

Assume that the dot inversion drive is used while such pattern displacement is occurring as shown in the lower-left part of FIG. 6. Then, a frame will be displayed as shown in FIG. 8A and FIG. 8B. As shown in FIG. 8A, in any odd-numbered frame, the pixels of any odd-numbered row (e.g., pixels connected to the scan lines G(1) and G(2)) appear darker than they appear at their innate grayscale level, and the pixels of any even-numbered row (e.g., pixels connected to the scan lines G(3) and G(4)) appear brighter than they appear at their innate grayscale level. In contrast, as shown in FIG. 8B, in any even-numbered frame, the pixels of any odd-numbered row (e.g., pixels connected to the scan lines G(1) and G(2)) appear brighter than they appear at their innate grayscale level, and the pixels of any even-numbered row (e.g., pixels connected to the scan lines G(3) and G(4)) appear darker than they appear at their innate grayscale level. In either case, the pixels change in brightness at every other pixel row, and horizontal stripes will inevitably appear on the display panel 100.

Also assume that the column inversion drive is used while such pattern displacement is occurring as shown in the lower-left part of FIG. 6. A frame will then be displayed as shown in FIG. 9A and FIG. 9B. As shown in FIG. 9A, in any odd-numbered frame, the pixels of all rows appear darker than they appear at their innate grayscale level, and as shown in FIG. 9B, in any even-numbered frame, the pixels of all rows appear brighter than they appear at their innate grayscale level. In either case, the pixels change in brightness at every other image (frame), and plane flicker is observed on the display panel 100.

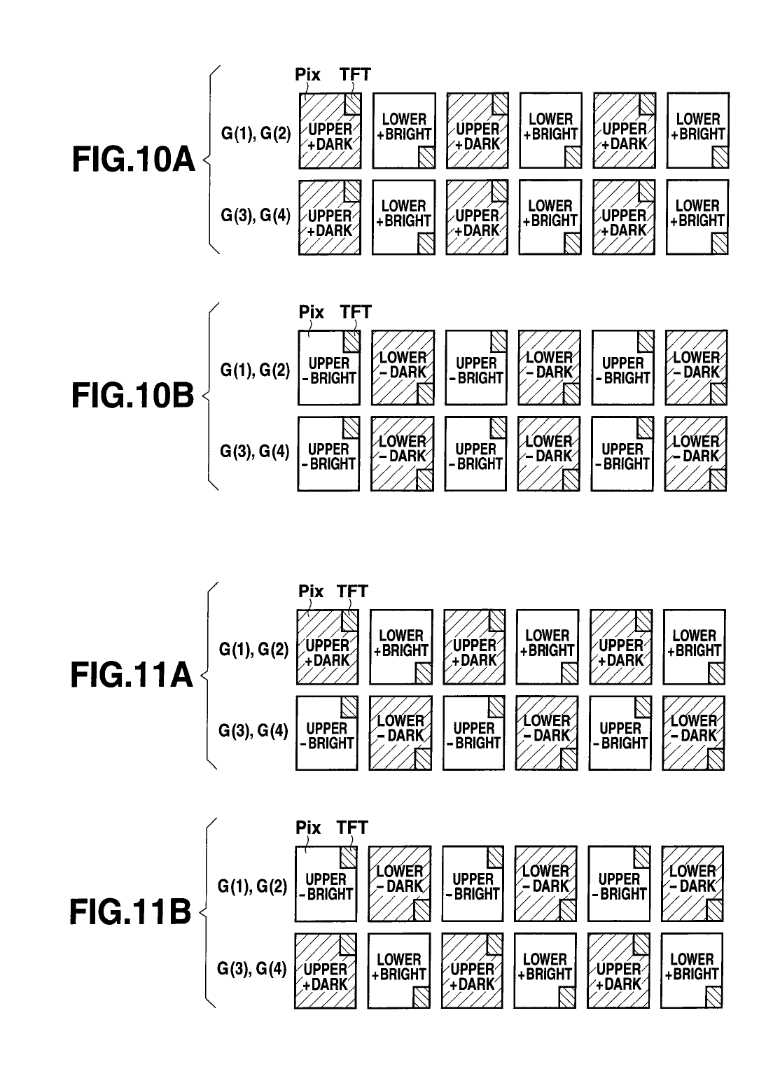

Further assume that the frame inversion is used while such pattern displacement is occurring as shown in the lower-left part of FIG. 6. Then, a frame will be displayed as shown in FIG. 10A and FIG. 10B. As shown in FIG. 10A, in any odd-numbered frame, the pixels of each column appear alternately dark and bright. As shown in FIG. 10B, in any even-numbered frame, the pixels of each column appear alternately bright and dark. In either case, the pixels change in brightness at every other pixel column, and vertical stripes will inevitably appear on the display panel 100.

In the embodiment, of the pixels constituting any column in the display panel 100, half are connected to an odd-numbered scan line G(i) and the remaining half are connected to an even-numbered scan line G(i) as shown in FIG. 3, and the line inversion drive is performed. As a result, a frame is displayed as shown in FIG. 11A or FIG. 11B. That is, as shown in FIG. 11A, of the pixels of any odd-numbered frame, those of each odd-numbered row (e.g., pixels connected to the scan lines G(1) and G(2)), appear alternately dark and bright, and those of each even-numbered row (e.g., pixels connected to the scan lines G(3) and G(4)), appear alternately bright and dark. As shown in FIG. 11B, of the pixels of any even-numbered frame, those of each odd-numbered row (e.g., pixels connected to the scan lines G(1) and G(2)), appear alternately bright and dark, and those of each even-numbered row (e.g., pixels connected to the scan lines G(3) and G(4)), appear alternately dark and bright. In this case, no brightness non-uniformity is observed, in terms of spatial average of one frame. Hence, the influence of plane flicker, horizontal stripes and vertical stripes are controlled.

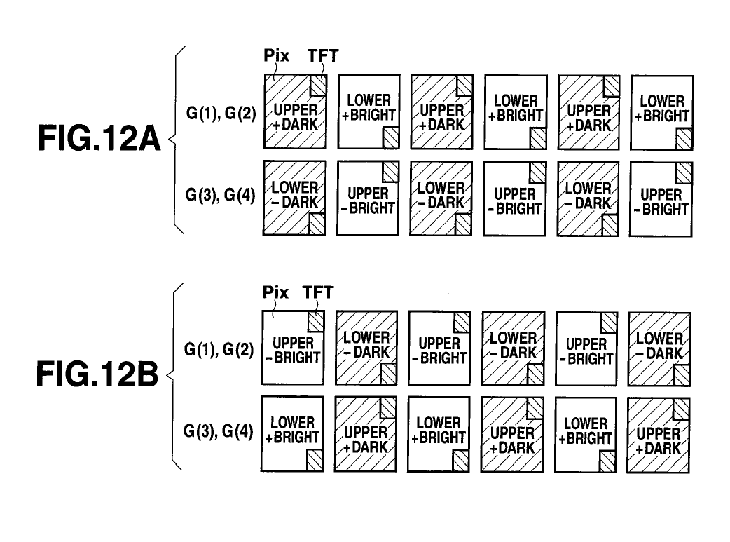

Even if the line inversion drive is performed, however, display non-uniformity will result unless the pixels are connected to the scan lines G(i) as shown in FIG. 3. If the line inversion drive is performed in a display panel 100 wherein the pixels of any column are alternately connected to an odd-numbered scan line G(i) and an even-numbered scan line G(i), frames will be displayed as shown in FIG. 12A and FIG. 12B. As shown in FIG. 12A, the pixel of each column appears alternately dark and bright in any odd-numbered frame. As shown in FIG. 12B, the pixel of each column appears alternately bright and dark in any even-numbered frame. In this case, the brightness of the pixels changes at every other pixel column, and display non-uniformity will result in the form of vertical stripes.

As has been described, the embodiment has a display panel 100 of stripe arrangement, in which any two adjacent pixels arranged on one side and the other of a signal line S(i), respectively, are connected to an odd-numbered scan line G(i) and an even-numbered scan line G(i), respectively. Further, the line inversion drive is performed, inverting the polarity of the display signal at every two other scan lines. Therefore, this can suppress the generation of plane flicker, vertical stripes and horizontal stripes that result from the pattern displacement of the pixels.

While an embodiment of the invention has been described, the embodiment is not intended to limit the scope of the present invention. Rather, various modifications and changes can, of course, be made without departing from the scope and spirit of the invention. For example, although both the display signal Vsig and the common voltage Vcom are inverted in polarity in the line inversion drive, the common voltage Vcom may be fixed and only the display signal Vsig may be inverted in polarity in the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display apparatus comprising an active-matrix type display panel and a signal drive circuit, the active-matrix type display panel comprising:
a pair of substrates,
a liquid crystal layer interposed between the substrates,
a plurality of pixel electrodes arranged on an inner surface of one of the substrates, in rows and columns in a form of a matrix,
a plurality of switching elements connected to the pixel electrodes,
a plurality of scan lines connected to the switching elements, and
a plurality of signal lines connected to the switching elements,
wherein the each signal line extends between two columns of the pixel electrodes, and the two pixel electrodes adjacent in the row direction use one signal line in common, one of the two pixel electrodes connected by the switching element to an odd-numbered scan line, and the other of the two pixel electrodes connected by the switching element to an even-numbered scan line; and
the signal drive circuit supplies display signals to the pixel electrodes through the signal lines, and inverts the display signal in polarity at every two other scan lines.

2. The liquid crystal display apparatus of claim 1, wherein the signal drive circuit inverts the display signal in polarity at every other row of pixel electrodes arranged in the display panel.

3. The liquid crystal display apparatus of claim 1, wherein the display panel further comprises a counter electrode formed on an inner surface of the other of the substrates, and a common voltage applying circuit is further provided to apply a common voltage to the counter electrode,
wherein the common voltage applying circuit inverts the common voltage in polarity at every other row of pixel electrodes of the display panel.

4. The liquid crystal display apparatus of claim 2, wherein the display panel further comprises a counter electrode formed on an inner surface of the other of the substrates, and a common voltage applying circuit is further provided to apply a common voltage to the counter electrode,
wherein the common voltage applying circuit inverts the common voltage in polarity at every other row of pixel electrodes of the display panel.

5. The liquid crystal display apparatus of claim 1, wherein the display panel further comprises a counter electrode formed on an inner surface of the other of the substrates, and a common voltage applying circuit is further provided to apply a common voltage to the counter electrode, and the common voltage applying circuit maintains the common voltage at a fixed value.

6. The liquid crystal display apparatus of claim 2, wherein the display panel further comprises a counter electrode formed on an inner surface of the other of the substrates, and a common voltage applying circuit is further provided to apply a common voltage to the counter electrode, and the common voltage applying circuit maintains the common voltage at a fixed value.

7. The liquid crystal display apparatus of claim 1, wherein the pixel electrodes of a first row are arranged between first and second scan lines; when the scan signal on the first scan line changes to a gate-on level, the signal drive circuit supplies a display signal to the pixel electrode on one side of the signal line and connected to the first scan line, through the switching element connected to the first scan line, thereby to drive every other pixel electrode of the first row; and when the scan signal on the second scan line changes to the gate-on level, the signal drive circuit supplies a display signal to the pixel electrode on the other side of the signal line and connected to the second scan line, through the switching element connected to the second scan line, thereby to drive the remaining pixel electrodes of the first row.

8. The liquid crystal display apparatus of claim 1, wherein plane flicker, horizontal stripes and vertical stripes changing brightness at the pixel electrodes, at every other row of pixel electrodes and at every other column of pixel electrodes, respectively, are suppressed even if the pixel electrode have undergone pattern displacement.

9. A method of driving a liquid crystal display apparatus comprising an active-matrix type display panel and a signal drive circuit,
the display panel comprising a pair of substrates, a liquid crystal layer interposed between the substrates, a plurality of pixel electrodes arranged on an inner surface of one of the substrates, in rows and columns in the form of a matrix, a plurality of switching elements connected to the pixel electrodes, a plurality of scan lines connected to the switching elements, and a plurality of signal lines connected to the switching elements, each signal line extending between two columns of pixel electrodes, and any two pixel electrodes adjacent in the row direction using one signal line in common, one connected by a switching element to an odd-numbered scan line, and the other connected by a switching element to an even-numbered scan line, and
the signal drive circuit configured to supply display signals to the pixel electrodes through the signal lines, thereby to display an image,
the method comprising inverting the display signal is inverted in polarity at every two other scan lines by the signal drive circuit.

10. The method of claim 9, wherein the display signal is inverted in polarity at every two other scan lines by inverting the display signal in polarity at every other row of pixel electrodes arranged in the display panel

11. The method of claim 9, wherein the display panel further comprises a counter electrode formed on an inner surface of the other substrate, a common voltage applying circuit is used to apply a common voltage to the counter electrode, and
the method further comprising inverting the common voltage in polarity at every other row of pixel electrodes of the display panel by the common voltage applying circuit.

12. The method of claim 10, wherein the display panel further comprises a counter electrode formed on an inner surface of the other substrate, a common voltage applying circuit is used to apply a common voltage to the counter electrode, and
the method further comprising inverting the common voltage in polarity at every other row of pixel electrodes of the display panel by the common voltage applying circuit.

13. The method of claim 9, wherein the display panel further comprises a counter electrode formed on an inner surface of the other of the substrates, a common voltage applying circuit is used to apply a common voltage to the counter electrode of the display panel, and
the method further comprising maintaining the common voltage at a fixed value by the common voltage applying circuit.

14. The method of claim 10, wherein the display panel further comprises a counter electrode formed on an inner surface of the other of the substrates, a common voltage applying circuit is used to apply a common voltage to the counter electrode of the display panel, and
the method further comprising maintaining the common voltage at a fixed value by the common voltage applying circuit.

15. The method of claim 9, in which the pixel electrodes of a first row are arranged between first and second scan lines, and
the method further comprising:
supplying a display signal to the pixel electrode on one side of the signal line and connected to the first scan line, when the scan signal on the first scan line changes to a gate-on level, through a switching element connected to the first scan line, thereby to drive every other pixel electrode of the first row; and
supplying a display signal to the pixel electrode on the other side of the signal line and connected to the second scan line, when the scan signal on the second scan line changes to the gate-on level, through the switching element connected to the second scan line, thereby to drive the remaining pixel electrodes of the first row.

16. The method of claim 9, wherein plane flicker, horizontal stripes and vertical stripes changing brightness at the pixel electrodes, at every other row of pixel electrodes and at every other column of pixel electrodes, respectively, are suppressed even if the pixel electrode have undergone pattern displacement.
